(19) United States
(12) Patent Application Publication
(10) Pub. No.: US 2018/0191041 A1
(43) Pub. Date: Jul. 5, 2018

(54) WATER-COOLED BATTERY MODULE OF ELECTRIC VEHICLE

(71) Applicants: Hyundai Motor Company, Seoul (KR); Kia Motors Corporation, Seoul (KR)

(72) Inventors: Yoon Cheol Jeon, Suwon (KR); Dal Kim, Yongin (KR)

(21) Appl. No.: 15/641,768

(22) Filed: Jul. 5, 2017

(30) Foreign Application Priority Data
Jan. 4, 2017 (KR) 10-2017-0001503

(51) Int. Cl. H01M 10/6556; H01M 10/625; H01M 10/613; H01M 10/6551; H01M 10/6567

(52) U.S. Cl. CPC H01M 10/6556; H01M 10/625; H01M 2220/20; H01M 10/6551; H01M 10/6567; H01M 10/613

(57) ABSTRACT

A water-cooled battery module of an electric vehicle is provided. According to the water-cooled battery module, cooling efficiency between a heat exchange pad and battery cells is enhanced since the heat exchange pad through which a cooling medium flows is made of a material having high heat transfer efficiency. Further, since heat dissipation plates with which the battery cells contact are in uniform surface contact with the heat exchange pad, cooling efficiency is enhanced by virtue of the uniform contact.

### CROSS REFERENCE TO RELATED APPLICATION

The present application claims priority of Korean Patent Application No. 10-2017-0001503 filed on Jan. 4, 2017, the entire contents of which is incorporated herein for all purposes by this reference.

### BACKGROUND

### Field of the Invention

The present invention relates to a water-cooled battery module of an electric vehicle for cooling heat generated in the battery module, and more particularly, to a water-cooled battery module that enhances cooling efficiency of battery cells by enhancing efficiency of heat exchange between a water-cooling cooling medium and battery cells.

### Description of the Related Art

In recent years, interest in environment-friendly vehicles has been increasing due to environmental problems, high oil price and the like and electric vehicles and hybrid vehicles capable of driving using electric energy have been developed. As a battery module applied to such electric vehicles and hybrid vehicles, a battery cell unit composed of a plurality of battery cells has been used. In particular, a plurality of battery cell units are accommodated and stacked in a single battery pack casing wherein the number of battery cell units is determined based on a required electric power.

The battery cell disposed within the battery module includes a cooling structure for cooling the battery cell due to heat generated during charging or discharging of the battery cell. The cooling structure of the battery module is divided into an air-cooled type and a water-cooled type wherein in the case of the water-cooled type cooling structure, the battery cell is indirectly cooled by a water-cooled plate.

In other words, the water-cooled type cooling structure is configured in a manner that cooling water is circulated in the water-cooled plate and an interface thermal contact material is disposed between the water-cooled plate and the battery cell to reduce thermal resistance between the water-cooled plate and the battery cell. However, when surface roughness or machining flatness of contact surfaces of the water-cooled plate is poor, resistance of internal heat exchange increases due to non-uniform contact with the battery cell. Further, since the water-cooled plate is made of a metal material such as aluminum or copper having high thermal conductivity, it is also difficult to construct in the water-cooled plate a cooling pipe through which cooling water flows.

As the foregoing described as the background art is merely to promote better understanding of the background of the present invention, it must not be taken as an admission that it corresponds to the prior art well known to those who have ordinary skill in the art.

### SUMMARY

The present invention provides a water-cooled battery module of an electric vehicle, which is configured to enhance cooling efficiency of battery cells by enhancing efficiency of heat exchange between a water-cooled cooling medium and battery cells.

A water-cooled battery module of an electric vehicle according to the present invention may include a plurality of battery cells arranged inside a battery casing; heat dissipation plates disposed between the plurality of battery cells respectively to dissipate heat generated in the battery cells; and a heat exchange pad disposed inside the battery casing to exchange heat with the plurality of heat dissipation plates, formed with a cooling flow path through which a cooling medium flows and made of a material having high heat transfer efficiency.

The battery cells and the heat dissipation plates are disposed in such a manner that they are stacked alternately inside the battery casing and the heat exchange pad is disposed on a top end, a bottom end, or a side end(s) of the battery casing depending on direction of arrangement of the battery cells and the heat dissipation plates. The battery cells and the heat dissipation plates may be disposed to be inserted vertically inside the battery casing and arranged along a horizontal direction, while the heat exchange pad is disposed on a top end or a bottom end of the battery casing to be positioned at one common end of the battery cells and the heat dissipation plates. Further, the battery cells and the heat dissipation plates may be disposed to be inserted horizontally inside the battery casing and arranged along a vertical direction, while a plurality of heat exchange pads are respectively disposed at both side ends of the battery casing to be positioned at both ends of the battery cells and the heat dissipation plates.

The heat exchange pad may include a lower thermal contact pad formed with a lower flow path groove and made of a material having high heat transfer efficiency; a cooling pipe disposed in the lower flow path groove of the lower thermal contact pad and formed with the cooling flow path through which the cooling medium flows; and an upper thermal contact pad formed to cover the top end of the lower thermal contact pad, formed with an upper flow path groove that corresponds to the lower flow path groove and made of a material having high heat transfer efficiency. The lower flow path groove and the upper flow path groove may be formed to extend in a zigzag form across the surfaces of the lower thermal contact pad and the upper thermal contact pad. The heat exchange pad may be made of a material in which ceramic powder having high thermal conductivity is mixed with a silicone material.

According to the water-cooled battery module of an electric vehicle, which is configured as described above, cooling efficiency between the heat exchange pad and the battery cells may be enhanced since the heat exchange pad through which the cooling medium flows is made of a material having high heat transfer efficiency. Further, since the heat dissipation plates with which the battery cells contact are in uniform surface contact with the heat exchange pad, cooling efficiency may be enhanced by virtue of the uniform contact.

### BRIEF DESCRIPTION OF THE DRAWINGS

The above and other features of the present disclosure will be more apparent from the following detailed description taken in conjunction with the accompanying drawings:

FIG. 1 is a view of a water-cooled battery module of an electric vehicle according to an exemplary embodiment of the present invention; and

FIGS. 2 to 4 are views illustrating a water-cooled battery module of an electric vehicle shown in FIG. 1 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

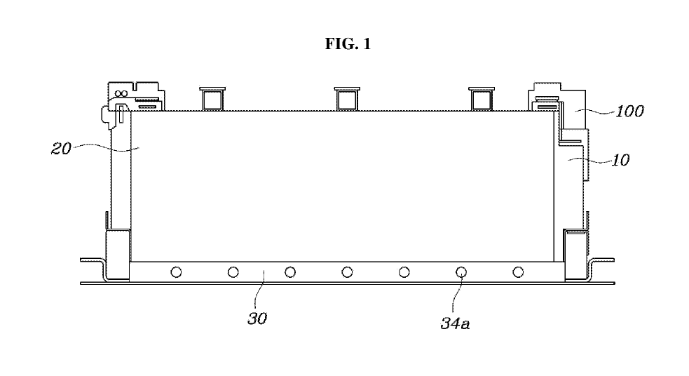

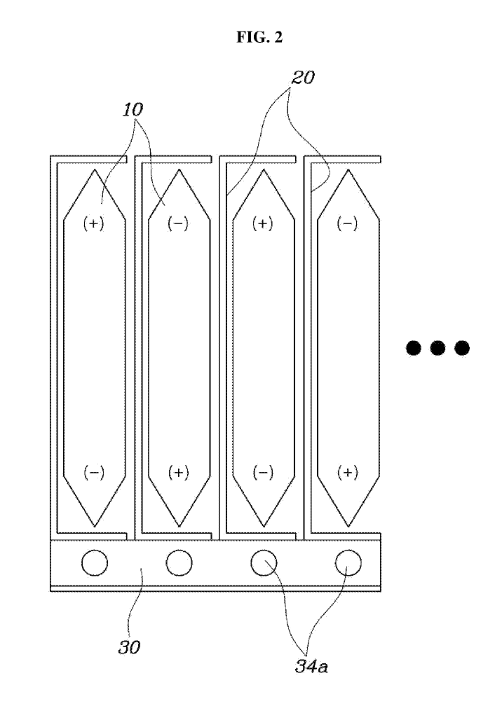

A water-cooled battery module of an electric vehicle according to an exemplary embodiment of the present invention will now be described in detail with reference to the accompanying drawings. However, the present invention is not limited or restricted by the exemplary embodiments. FIG. 1 is a view of a water-cooled battery module of an electric vehicle according to an exemplary embodiment of the present invention and FIGS. 2 to 4 are views illustrating a water-cooled battery module of an electric vehicle shown in FIG. 1.

As shown in FIG. 1, a water-cooled battery module of an electric vehicle according to the present invention may include a plurality of battery cells 10 disposed inside a battery casing 100; heat dissipation plates 20 disposed between the plurality of battery cells 10 respectively to dissipate heat generated in the battery cells 10; and a heat exchange pad 30 disposed inside the battery casing 100 to exchange heat with the plurality of heat dissipation plates 20, formed with a cooling flow path 34a through which a cooling medium flows and made of a material having high heat transfer efficiency.

As described above, the present invention is intended to efficiently cool the battery cells 10 disposed within the battery casing 100, wherein heat dissipation plates 20 for dissipating heat generated in the battery cells 10 may be disposed between the plurality of battery cells 10 respectively and the heat dissipation plates 20 may be configured to exchange heat with a cooling medium flowing through the cooling flow path 34a formed inside the heat exchange pad 30, thereby cooling the battery cells 10.

In this exemplary embodiment, the battery cells 10 and the heat dissipation plates 20 may be arranged to be stacked alternately inside the battery casing 100 and the plurality of battery cells 10 may be electrically connected in series or in parallel through electrode tabs. The heat dissipation plates 20 may be disposed between the plurality of battery cells 10 respectively and may be configured to absorb and dissipate heat generated in the battery cells 10. The heat dissipation plates 20 may be made of a material having high thermal conductivity such as an aluminum material.

Particularly, in the present invention, the heat exchange pad 30 which exchanges heat with the heat dissipation plates 20 may be made of a material having high heat transfer efficiency to cause the heat exchange pad to exchange heat with the heat dissipation plates 20 which absorbs heat transmitted from the battery cells 10. The heat exchange pad 30 may also be formed inside with the cooling flow path 34a. The cooling flow path 34a allows the cooling medium to flow therethrough causing the cooling medium to exchange heat with the battery cells 10 via the heat exchange pad 30 and the heat dissipation plate 20 and in turn the battery cells 10 may thus be cooled.

In the prior art, however, when a cooling medium passing through battery cells and a cooling flow path is heat exchanged with each other, the heat exchange is executed through a water cooling plate, an interface material for heat transfer, a heat dissipation plate and the like, and thus, thermal resistance is increased and therefore cooling efficiency is decreased. However, in the present invention, upon mutual heat exchange between the battery cells 10 and the cooling medium, the heat exchange is executed through the heat dissipation plate 20 and the heat exchange pad 30 and thus, thermal resistance may be reduced compared to the prior art. Further, since the heat exchange pad 30 may be made of the material having high heat transfer efficiency, capability of heat exchange between the battery cells 10 and the cooling medium may be enhanced, thereby enhancing cooling efficiency.

As described above, the present invention is configured such that the battery cells 10 may be arranged in parallel within the battery casing 100, the heat dissipation plates 20 may be disposed between the battery cells 10 respectively and the heat dissipation plates 20 exchanges heat with the heat exchange pad 30 through the cooling medium flows. Particularly, since the heat exchange pad 30 may be made of the material having high heat transfer efficiency, efficient heat exchange with the heat dissipation plates 20 may be performed and therefore cooling efficiency of the battery cells 10 may be enhanced. The present invention will now be described in detail.

The heat exchange pad 30 may be made of a material in which ceramic powder having high thermal conductivity is mixed with a silicone material. In particular, the heat exchange pad 30 may be made of a silicon-based material to be flexible or deformable by a predetermined amount and the silicon is mixed with the ceramic powder having excellent thermal conductivity, and thus, the capability of heat exchange between the cooling medium flowing through the cooling flow path 34a and the heat dissipation plates 20 may be enhanced.

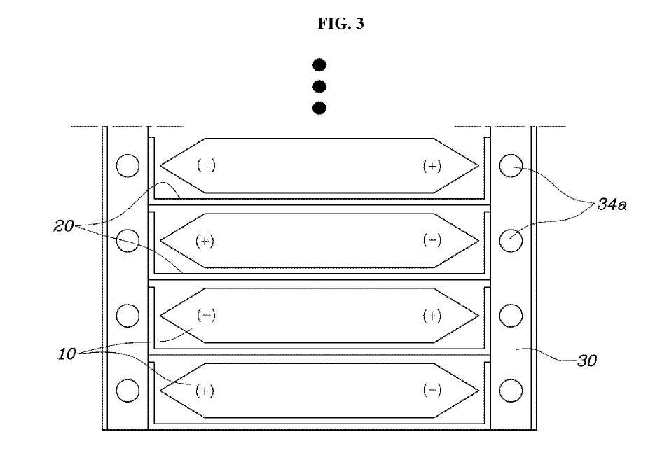

Further, as shown in FIGS. 2 to 3, the battery cells 10 and the heat dissipation plates 20 may be arranged to be alternately stacked inside the battery casing 100 and the heat exchange pad 30 may be disposed on a top end, a bottom end, or a side end of the battery casing 100 depending on direction of arrangement of the battery cells 10 and the heat dissipation plates 20.

As described above, the battery cells 10 and the heat dissipation plates 20 may be stacked within the battery casing 100 in a variety of directions such as a horizontal direction or a longitudinal direction. In particular, when the heat exchange pad 30 and the heat dissipation plates 20 are disposed to be in surface contact with each other, any one of the plurality of battery cells 10 may be only cooled when the battery cells 10 and the heat dissipation plates 20 are cooled through the heat exchange pad 30. Therefore, the heat exchange pad 3 may be disposed to exchange heat with an end of the battery cells 10 and the heat dissipation plates 20 in consideration of the direction of arrangement of the battery cells 10 and the heat dissipation plates 20 to uniformly cool the plurality of battery cells.

Specifically, each heat dissipation plate 20 may be disposed between the battery cells 10 wherein each heat dissipation plate 20 may be formed to surround each battery cell 10. Accordingly, as shown in FIG. 2, the battery cells 10 and the heat dissipation plates 20 may be disposed to be inserted vertically inside the battery casing 100 and arranged along a horizontal direction, while the heat exchange pad 30 may be disposed on a top end or a bottom end of the battery casing 100 to be positioned at one common end of the battery cells 10 and the heat dissipation plates 20. Accordingly, the plurality of battery cells 10 and the heat dissipation plates 20 may exchange heat with the heat exchange pad 30.

When the battery cells 10 and the heat dissipation plates 20 are disposed to be arranged along the horizontal direction, the heat exchange pad 30 may be disposed at both the top and bottom ends of the battery cells 10 and the heat dissipation plates 20. Particularly, the heat exchange pad 30 may be preferably disposed under the bottom end of the battery cells 10 and the heat dissipation plates 20. Since the heat exchange pad 30 may be made of the material in which ceramic powder having high thermal conductivity is mixed with a silicon material, weight of the battery cells 10 and the heat dissipation plates 20 disposed on the top end of the heat exchange pad 30 presses against the heat exchange pad 30 and thus, the heat dissipation plates 20 may be in surface contact with the heat exchange pad 30.

In particular, each heat dissipation plate 20 may be formed to surround each battery cell 10 and the bottom ends of each heat dissipation plate 20 may be formed to have planes respectively, and thus, the bottom ends of the heat dissipation plates 20 are in contact with the top surfaces of the heat exchange pad 30 and weight of the battery cells 10 and the heat dissipation plates 20 may be applied to the heat exchange pad 30. Additionally, since the silicon material of the heat exchange pad 30 is a base material, the heat exchange pad may be deformed by a predetermined amount and the bottom ends of the heat dissipation plates 20 may be pressed against and cling (e.g., abut) to the heat exchange pad 30 by weight of the battery cells 10 and the heat dissipation plates 20 so that the heat dissipation plates 20 are in surface contact with the heat exchange pad 30. Accordingly, surface pressure is formed on the heat exchange pad 30 by the weight of the battery cells 10 and the heat dissipation plates 20 to maintain uniform contact relationship and therefore enhance heat transfer efficiency.

Furthermore, as shown in FIG. 3, the battery cells 10 and the heat dissipation plates 20 may be disposed to be inserted horizontally inside the battery casing 100 and arranged along a vertical direction, while a plurality of heat exchange pads 30 may be disposed respectively at both side ends of the battery casing 100 to be positioned at both ends of the battery cells 10 and the heat dissipation plates 20. When the battery cells 10 and the heat dissipation plates 20 are disposed to be arranged along the horizontal direction as described above, the heat exchange pads 30 may be disposed at both side ends of the battery cells 10 and the heat dissipation plates 20 to exchange heat with the battery cells 10 and the heat dissipation plates 20.

Particularly, when the heat exchange pads 30 are disposed at both side ends of the inside of the battery casing 100, the heat dissipation plates 20 and the heat exchange pads 300 are in contact with each other due to the pressing force of end plates of the battery casing 100. As described above, when the direction of stacking the battery cells is determined based on design of the battery unit, the heat exchange pads may be disposed at the top and bottom ends or the side ends of the battery casing to efficiently cool the battery cells.

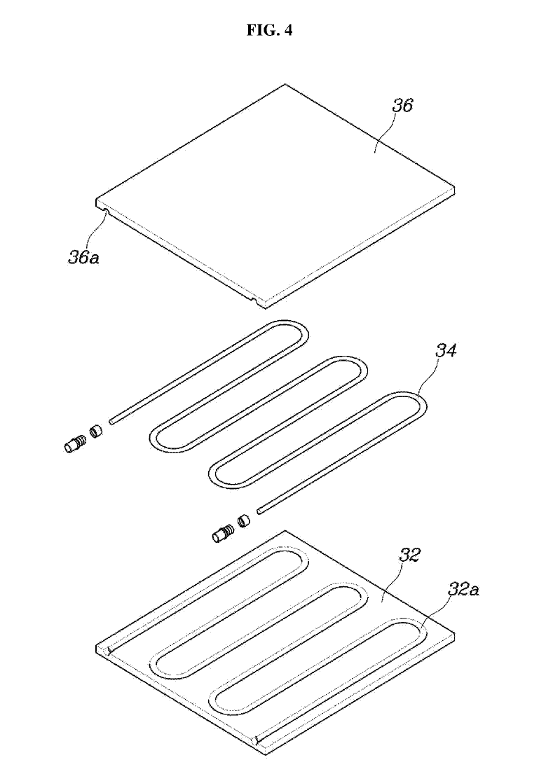

Additionally, as shown in FIG. 4, the heat exchange pad 30 may include a lower thermal contact pad 32 formed with a lower flow path groove 32a and made of a material having high heat transfer efficiency; a cooling pipe 34 disposed in the lower flow path groove 32a of the lower thermal contact pad 32 and formed with the cooling flow path 34a through which the cooling medium flows; and an upper thermal contact pad 36 formed to cover the top end of the lower thermal contact pad 32, formed with an upper flow path groove 36a that corresponds to the lower flow path groove 32a and made of a material having high heat transfer efficiency.

As described above, the heat exchange pad 30 may include the lower thermal contact pad 32, the cooling pipe 34 and the upper thermal contact pad 36 wherein the cooling pipe 34 may be interposed between the lower thermal contact pad 32 and the upper thermal contact pad 36. In particular, the lower thermal contact pad 32 may be formed with the lower flow path groove 32a, the upper thermal contact pad 36 may be formed with the upper flow path groove 36a and the cooling pipe 34 may be disposed in the lower flow path groove 32a and the upper flow path groove 36a, and thus, the cooling medium flowing through the cooling pipe 34 may exchange heat with the lower thermal contact pad 32 and the upper thermal contact pad 36. Both the lower thermal contact pad 32 and the upper thermal contact pad 36 may be made of a material in which ceramic powder having excellent thermal conductivity is mixed with a silicon material and the cooling pipe 34 may be made of aluminum or copper having high thermal conductivity.

The cooling medium flowing through the cooling pipe 34 may be cooling water and the cooling medium to be cooled as it passes through a radiator may be circulated by a cooling pump to the cooling pipe 34 of the battery module as well as various devices including cylinders. Particularly, as shown in FIG. 4, the lower flow path groove 32a and the upper flow path groove 36a may be formed to extend in a zigzag form (e.g., a serpentine shape) across the surfaces of the lower thermal contact pad 32 and the upper thermal contact pad 36. Accordingly, the cooling pipe 34 may also be formed in a zigzag form (e.g., a serpentine shape) to correspond to the lower flow path groove 32a and the upper flow path groove 36a.

As described above, since the cooling pipe 34 may be formed in a corresponding shape to the lower flow path groove 32a and the upper flow path groove 36a, the cooling medium may circulate throughout the whole area of the lower thermal contact pad 32 and the upper thermal contact pad 36. In other words, as shown in FIG. 3, since the lower flow path groove 32a may be formed to extend in the zigzag or serpentine form to form the cooling flow path throughout the whole area of the lower thermal contact pad 32 and the upper flow path groove 36a may also be formed to extend to form the cooling path throughout the whole area of the upper thermal contact pad 36, it may be possible to circulate the cooling medium throughout the whole area of the thermal contact pads when the cooling pipe 34 formed to correspond to the lower flow path groove 32a and the upper flow path groove 36a is interposed between the lower heat contact pad 32 and the upper heat contact pad 36 and the cooling medium is circulated in the cooling pipe. As a result, since the cooling medium may be circulated throughout the whole area of the heat exchange pad 30, the heat exchange pad may exchange heat with all of the plurality of battery cells 10 arranged within the battery casing 100 thus securing performance of cooling the battery cells 10.

According to the water-cooled battery module of an electric vehicle, which is configured as described above, cooling efficiency between the heat exchange pad and the battery cells may be enhanced since the heat exchange pad through which the cooling medium flows may be made of a material having high heat transfer efficiency. Further, since the heat dissipation plates with which the battery cells contact are in uniform surface contact with the heat exchange pad, cooling efficiency may be enhanced by virtue of the uniform contact.

Although the present invention has been described and illustrated with respect to exemplary embodiments, it will be apparent by those who have ordinary skill in the art that various modifications and changes to the present invention may be made without departing from the spirit and scope of the present invention as defined in the appended patent claims.

What is claimed is:

1. A water-cooled battery module of an electric vehicle, comprising:
a plurality of battery cells disposed inside a battery casing;
a plurality of heat dissipation plates disposed between the plurality of battery cells respectively to dissipate heat generated in the battery cells; and
a heat exchange pad disposed inside the battery casing to exchange heat with the plurality of heat dissipation plates, formed with a cooling flow path through which a cooling medium flows and made of a material having high heat transfer efficiency.

2. The water-cooled battery module of claim 1, wherein the battery cells and the heat dissipation plates are alternately stacked inside the battery casing and the heat exchange pad is disposed on a top end, a bottom end, or a side end of the battery casing depending on direction of arrangement of the battery cells and the heat dissipation plates.

3. The water-cooled battery module of claim 2, wherein the battery cells and the heat dissipation plates are disposed to be inserted vertically inside the battery casing and arranged along a horizontal direction and wherein the heat exchange pad is disposed on a top end or a bottom end of the battery casing to be positioned at one common end of the battery cells and the heat dissipation plates.

4. The water-cooled battery module of claim 2, wherein the battery cells and the heat dissipation plates are disposed to be inserted horizontally inside the battery casing and arranged along a vertical direction and wherein a plurality of heat exchange pads are disposed respectively at both side ends of the battery casing to be positioned at both ends of the battery cells and the heat dissipation plates.

5. The water-cooled battery module of claim 1, wherein the heat exchange pad includes:
a lower thermal contact pad formed with a lower flow path groove and made of a material having high heat transfer efficiency;
a cooling pipe disposed in the lower flow path groove of the lower thermal contact pad and formed with the cooling flow path through which the cooling medium flows; and
an upper thermal contact pad formed to cover the top end of the lower thermal contact pad, formed with an upper flow path groove that corresponds to the lower flow path groove and made of a material having high heat transfer efficiency.

6. The water-cooled battery module of claim 5, wherein the lower flow path groove and the upper flow path groove are formed to extend in a zigzag form across the surfaces of the lower thermal contact pad and the upper thermal contact pad.

7. The water-cooled battery module of claim 5, wherein the cooling pipe is formed in a zigzag form to correspond to the lower flow path groove and the upper flow path groove.

8. The water-cooled battery module of claim 1, wherein the heat exchange pad is made of a material in which ceramic powder having high thermal conductivity is mixed with a silicone material.
